(19) United States
(12) Patent Application Publication
(10) Pub. No.: US 2015/0035726 A1
(43) Pub. Date: Feb. 5, 2015

(54) EYE-ACCOMMODATION-AWARE HEAD MOUNTED VISUAL ASSISTANT SYSTEM AND IMAGING METHOD THEREOF

(71) Applicant: QUANTA COMPUTER INC., TAO YUAN SHIEN (TW)

(72) Inventors: Chung-Te LI, New Taipei City (TW); Wen-Chu YANG, New Taipei City (TW); Chih-Chi CHENG, New Taipei City (TW)

(73) Assignee: QUANTA COMPUTER INC., TAO YUAN SHIEN (TW)

(21) Appl. No.: 14/065,742

(22) Filed: Oct. 29, 2013

(30) Foreign Application Priority Data
Aug. 2, 2013 (TW) 102127845

(51) Int. Cl. G02B 27/01

(52) U.S. Cl. CPC G02B 27/0176; G02B 2027/0178
USPC 345/8

(57) ABSTRACT

An eye-accommodation-aware head mounted visual assistant system and an imaging method thereof are disclosed. The eye-accommodation-aware head mounted visual assistant system comprises a beam splitter, a projecting light source, an image sensor, a calculating device, a controlling device, and an eyeglass frame. The projecting light source projects assistant information via beam splitter. The image sensor captures an eye image. The calculating device calculates an object distance and a viewing direction according to the eye image. The controlling device according to the object distance controls the projecting light source to adjust an image location of the assistant information, and controls the projecting light source to adjust a projecting light angle and an angle of the beam splitter according to the viewing direction. The eyeglass frame carries the projecting light source, the beam splitter, the image sensor, the calculating device and the controlling device.

This application claims the benefit of Taiwan application Serial No. 102127845, filed Aug. 2, 2013, the subject matter of which is incorporated herein by reference.

### BACKGROUND OF THE INVENTION

1. Field of the Invention

The invention relates in general to an electronic device, and more particularly to an eye-accommodation-aware head mounted visual assistant system and an imaging method thereof.

2. Description of the Related Art

Along with the advance in technology, people's access to information becomes more convenient. Most commonly seen electronic devices such as multi-media play devices, network communication devices and computers are equipped with a CRT or an LCD display for displaying images. However, the pixel and size of displayed images are restricted by the size and efficiency of display. Conventional CRT and LCD display both are incapable of satisfying the requirements of size and portability. To resolve the above problems, a head-mounted display (HMD) is provided in the market. The head-mounted display has a small-sized image tube or a liquid crystal display in front of left eye and right eye respectively. The head-mounted display projects image outputted by an image tube or a liquid crystal display onto a user's retinas via a beam splitter.

In a conventional head-mounted display (such as Google glasses), the focusing of the eyes needs to consider an object being viewed in the real world and assistant information thereof. Suppose the object and the presented assistant information are not located on the same imaging plane. In order to clearly see the real object and the assistant information, the eyes must keep adjusting crystalline lens to change focal distances so as to be adapted to two target objects located at different object distances. By doing so, the user's eyeballs may experience fatigue and feel discomfort.

### SUMMARY OF THE INVENTION

The invention is directed to an eye-accommodation-aware head mounted visual assistant system and an imaging method thereof.

According to one embodiment of the present invention, an eye-accommodation-aware head mounted visual assistant system is disclosed. The eye-accommodation-aware head mounted visual assistant system comprises a beam splitter, a projecting light source, an image sensor, a calculating device, a controlling device, and an eyeglass frame. The projecting light source projects assistant information via beam splitter. The image sensor captures an eye image. The calculating device calculates an object distance and a viewing direction according to the eye image. The controlling device controls the projecting light source to adjust an image location of the assistant information according to the object distance, and controls the projecting light source to adjust a projecting light angle and an angle of the beam splitter according to the viewing direction. The eyeglass frame carries the projecting light source, the beam splitter, the image sensor, the calculating device and the controlling device.

According to another embodiment of the present invention, an imaging method of an eye-accommodation-aware head mounted visual assistant system is disclosed. The imaging method of an eye-accommodation-aware head mounted visual assistant system comprises following steps. An eye image is captured via the image sensor. An object distance and a viewing direction are calculated according to the eye image. A projecting light source is controlled to adjust an image location of the assistant information according to the object distance and adjust a projecting light angle and an angle of the beam splitter according to the viewing direction.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 is an appearance diagram of an eye-accommodation-aware head mounted visual assistant system according to a first embodiment;

FIG. 2 is a block diagram of an eye-accommodation-aware head mounted visual assistant system according to a first embodiment;

FIG. 3 is a flowchart of an imaging method of an eye-accommodation-aware head mounted visual assistant system according to a first embodiment;

FIG. 4 is an appearance diagram of an eye-accommodation-aware head mounted visual assistant system according to a second embodiment;

FIG. 5 is a flowchart of an imaging method of an eye-accommodation-aware head mounted visual assistant system according to a second embodiment;

FIG. 6 is an appearance diagram of an eye-accommodation-aware head mounted visual assistant system according to a third embodiment;

FIG. 7 is a block diagram of an eye-accommodation-aware head mounted visual assistant system according to a third embodiment; and

FIG. 8 is a flowchart of an imaging method of an eye-accommodation-aware head mounted visual assistant system according to the third embodiment.

### DETAILED DESCRIPTION OF THE INVENTION

### First Embodiment

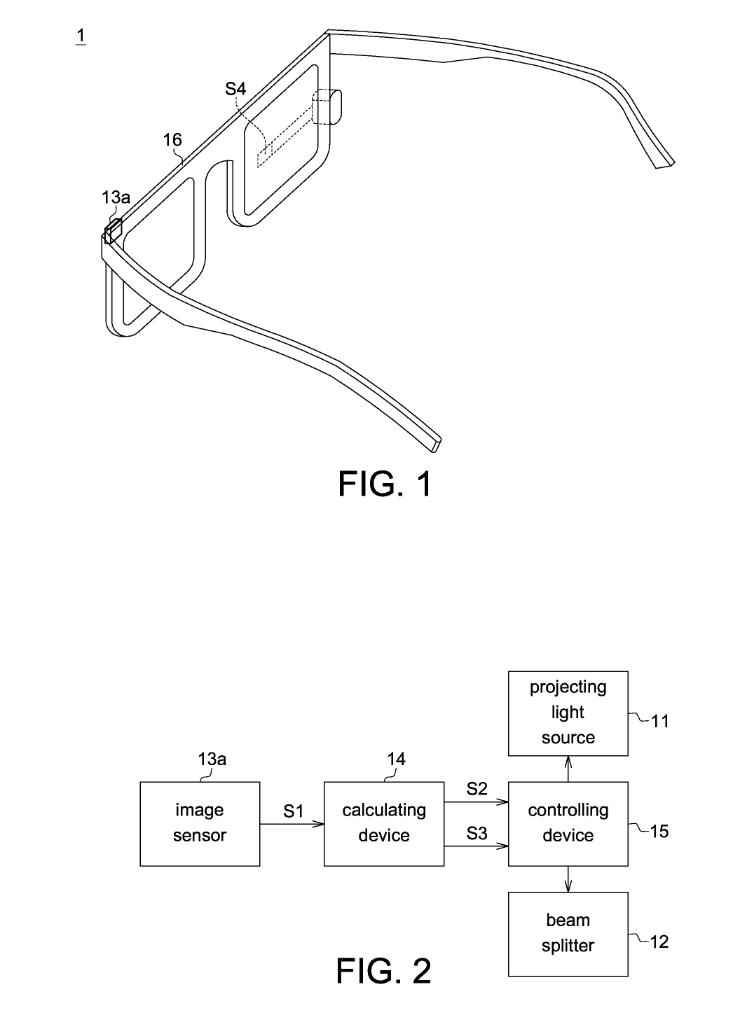

Referring to FIG. 1 and FIG. 2. FIG. 1 is an appearance diagram of an eye-accommodation-aware head mounted visual assistant system according to a first embodiment. FIG. 2 is a block diagram of an eye-accommodation-aware head mounted visual assistant system according to a first embodiment. The eye-accommodation-aware head mounted visual assistant system 1 comprises a projecting light source 11, a beam splitter 12, an image sensor 13a, a calculating device 14, a controlling device 15 and an eyeglass frame 16. The projecting light source 11 projects assistant information S4 via the beam splitter 12. The assistant information S4 is such as supplementary messages or images for an object viewed by a user.

The image sensor 13a captures an eye image S1. The image sensor 13a can be disposed at left inner side, right inner side or central inner side of the eyeglass frame 16. For convenience of elaboration, the image sensor 13a of FIG. 1 is disposed at the left inner side of the eyeglass frame 16. The image sensor 13a is such as an infrared image sensor. The eye-accommodation-aware head mounted visual assistant system 1 may further comprise an infrared assistant light source which provides an infrared light to assist the infrared image sensor to capture the eye image S1. When the eye image S1 is not clear, the infrared light can be used to improve the clarity of the eye image S1.

The calculating device 14 is such as a central processor or an integrated circuit. The calculating device 14 calculates an object distance S2 and a viewing direction S3 according to the eye image S1. The object distance S2 refers to distance between the user and an object viewed by the user. The viewing direction S3 refers to direction in which the user views the object. The controlling device 15 controls the projecting light source 11 to adjust an image location of the assistant information according to the object distance S2 and adjust a projecting light angle and an angle of the beam splitter 12 according to the viewing direction S3. The eyeglass frame 16 carries the projecting light source 11, the beam splitter 12, the image sensor 13a, the calculating device 14 and the controlling device 15.

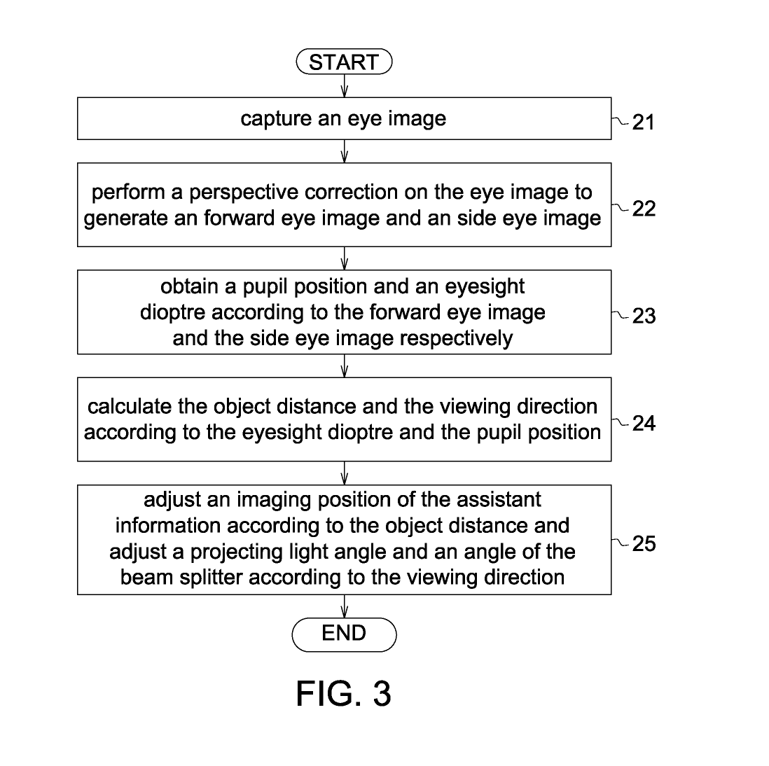

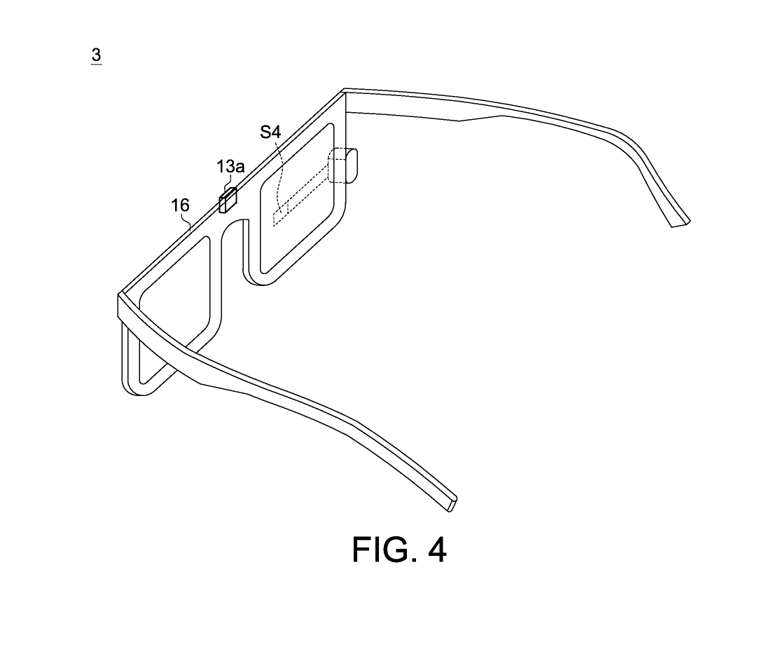

Referring to FIG. 2 and FIG. 3. FIG. 3 is a flowchart of an imaging method of an eye-accommodation-aware head mounted visual assistant system according to a first embodiment. The imaging method of an eye-accommodation-aware head mounted visual assistant system 1 comprises following steps. Firstly, the method begins at step 21, the image sensor 13a captures an eye image S1. Next, the method proceeds to step 22, the calculating device 14 performs a perspective correction on the eye image S1 to generate a forward eye image and a side eye image. Then, the method proceeds to step 23, the calculating device 14 obtains a pupil position and an eyesight dioptre according to the forward eye image and the side eye image respectively. After that, the method proceeds to step 24, the calculating device 14 calculates the object distance S2 and the viewing direction S3 according to the eyesight dioptre and the pupil position. Following that, the method proceeds to step 25, the controlling device 15 controls the projecting light source 11 to adjust an imaging position of the assistant information S4 according to the object distance S2 and adjust a projecting light angle and an angle of the beam splitter 12 according to the viewing direction S3.

The imaging position of the assistant information S4 can be flexibly adjusted according to actual object distance, and the projecting light angle and the angle of the beam splitter 12 can be appropriately adjusted according to the viewing direction S3. Thus, the user will experience less eye fatigue, feel more comfortable with viewing.

### Second Embodiment

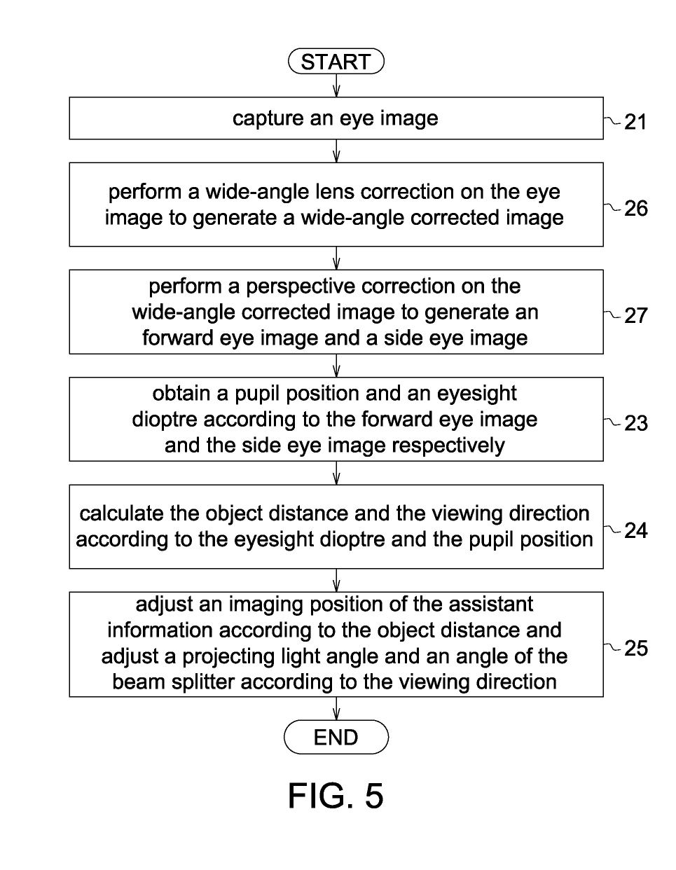

Referring to FIG. 1, FIG. 4 and FIG. 5. FIG. 4 is an appearance diagram of an eye-accommodation-aware head mounted visual assistant system according to a second embodiment. FIG. 5 is a flowchart of an imaging method of an eye-accommodation-aware head mounted visual assistant system according to a second embodiment. The eye-accommodation-aware head mounted visual assistant system 3 is different from the eye-accommodation-aware head mounted visual assistant system 1 mainly in that the image sensor 13a of the eye-accommodation-aware head mounted visual assistant system 3 is disposed at the central inner side of the eyeglass frame 16. The eye image S1 captured by the image sensor 13a of eye-accommodation-aware head mounted visual assistant system 3 comprises a left eye image and a right eye image, so the image sensor 13a needs to cooperate with a wide-angle lens. To avoid the eye image S1 being distorted, the imaging method of the eye-accommodation-aware head mounted visual assistant system 3 performs a wide-angle lens correction on the eye image S1 that needs to be captured.

The imaging method of the eye-accommodation-aware head mounted visual assistant system 3 comprises following steps. Firstly, the method begins at step 21, the image sensor 13a captures an eye image S1. Next, the method proceeds to step 26, the calculating device 14 performs a wide-angle lens correction on the eye image S1 to generate a wide-angle corrected image. Then, the method proceeds to step 27, the calculating device 14 performs a perspective correction on the wide-angle corrected image to generate a forward eye image and a side eye image. Then, the method proceeds to step 23, the calculating device 14 obtains a pupil position and an eyesight dioptre according to the forward eye image and the side eye image respectively. After that, the method proceeds to step 24, the calculating device 14 calculates an object distance S2 and a viewing direction S3 according to the eyesight dioptre and the pupil position. Following that, the method proceeds to step 25, the controlling device 15 controls the projecting light source 11 to adjust an imaging position of the assistant information S4 according to the object distance S2 and adjust a projecting light angle and an angle of the beam splitter 12 according to the viewing direction S3.

### Third Embodiment

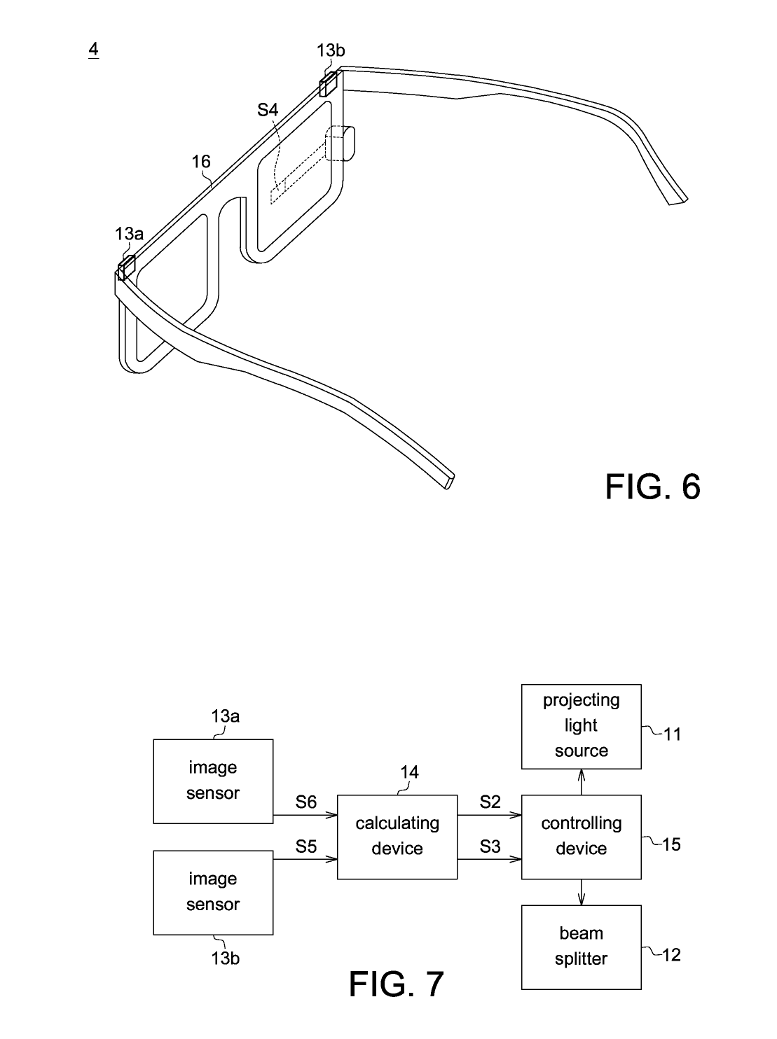

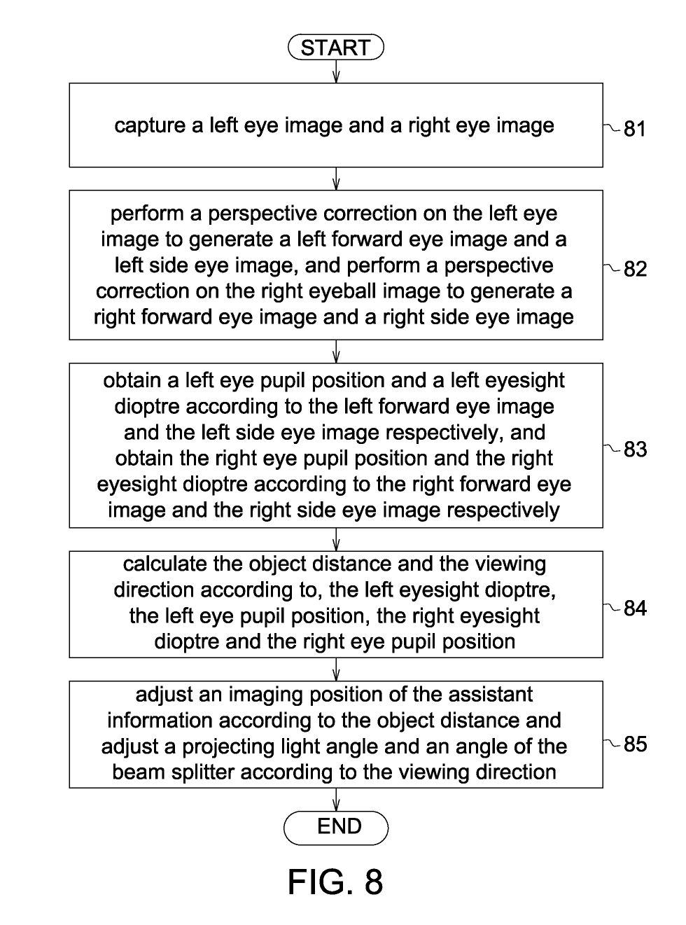

Referring to FIG. 1, FIG. 6, FIG. 7 and FIG. 8. FIG. 6 is an appearance diagram of an eye-accommodation-aware head mounted visual assistant system according to a third embodiment. FIG. 7 is a block diagram of an eye-accommodation-aware head mounted visual assistant system according to a third embodiment. FIG. 8 is a flowchart of an imaging method of an eye-accommodation-aware head mounted visual assistant system according to the third embodiment. The eye-accommodation-aware head mounted visual assistant system 4 is different from the eye-accommodation-aware head mounted visual assistant system 1 mainly in that the eye-accommodation-aware head mounted visual assistant system 3 further comprises an image sensor 13b. The image sensor 13a is disposed at the left inner side of the eyeglass frame 16, and the image sensor 13b is disposed at the right inner side of the eyeglass frame 16.

The imaging method of the eye-accommodation-aware head mounted visual assistant system 4 comprises following steps. Firstly, the method begins at step 81, the image sensor 13a captures a left eye image S6, and the image sensor 13b captures a right eye image S5. Following that, the method proceeds to 82, the calculating device 14 performs a perspective correction on the left eye image S6 to generate a left forward eye image and a left side eye image, and performs a perspective correction on the right eyeball image S5 to generate a right forward eye image and a right side eye image. Then, the method proceeds to 83, the calculating device 14 obtains a left eye pupil position and a left eyesight dioptre according to the left forward eye image and the left side eye image respectively, and obtains the right eye pupil position and the right eyesight dioptre according to the right forward eye image and the right side eye image respectively. After that, the method proceeds to 84, the calculating device 14 calculates the object distance S2 and the viewing direction S3 according to the left eyesight dioptre, the left eye pupil position, the right eyesight dioptre and the right eye pupil position. Following that, the method proceeds to 85, the controlling device 15 controls the projecting light source 11 to adjust an imaging position of the assistant information S4 according to the object distance S2 and adjust a projecting light angle and an angle of the beam splitter 12 according to the viewing direction S3.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An eye-accommodation-aware head mounted visual assistant system, comprising:
a beam splitter;
a projecting light source used for projecting an assistant information via the beam splitter;
a first image sensor used for capturing a first eye image;
a calculating device used for calculating an object distance and a viewing direction according to the first eye image; and
a controlling device used for controlling the projecting light source to adjust an imaging position of the assistant information according to the object distance and adjusting a projecting light angle and an angle of the beam splitter according to the viewing direction;
an eyeglass frame used for carrying the projecting light source, the beam splitter, the first image sensor, the calculating device and the controlling device.

2. The eye-accommodation-aware head mounted visual assistant system according to claim 1, wherein the first image sensor is an infrared image sensor.

3. The eye-accommodation-aware head mounted visual assistant system according to claim 2, further comprising:
an infrared assistant light source used for providing an infrared light to assist the infrared image sensor to capture the first eye image.

4. The eye-accommodation-aware head mounted visual assistant system according to claim 1, wherein the first image sensor is disposed at left inner side of the eyeglass frame.

5. The eye-accommodation-aware head mounted visual assistant system according to claim 1, wherein the first image sensor is disposed at right inner side of the eyeglass frame.

6. The eye-accommodation-aware head mounted visual assistant system according to claim 1, wherein the first image sensor is disposed at central inner side of the eyeglass frame.

7. The eye-accommodation-aware head mounted visual assistant system according to claim 1, wherein the calculating device performs a perspective correction on the first eye image to generate a first forward eye image and a first side eye image, obtains a first pupil position and a first eyesight dioptre according to the first forward eye image and the first side eye image respectively, and calculates an object distance and a viewing direction according to the first eyesight dioptre and the first pupil position.

8. The eye-accommodation-aware head mounted visual assistant system according to claim 1, further comprising:
a second image sensor used for capturing a second eye image;
wherein, the calculating device calculates an object distance and a viewing direction according to the first eye image and the second eye image.

9. The eye-accommodation-aware head mounted visual assistant system according to claim 8, wherein the calculating device performs a perspective correction on the first eye image to generate a first forward eye image and a first side eye image, obtains a first pupil position and a first eyesight dioptre according to the first forward eye image and the first side eye image respectively, performs the perspective correction on the second eye image to generate a second forward eye image and a second side eye image, obtains a second pupil position and a second eyesight dioptre according to the second forward eye image and the second side eye image respectively, and calculates an object distance and a viewing direction according to the first eyesight diopter, the second eyesight dioptre, the first pupil position, and the second pupil position.

10. The eye-accommodation-aware head mounted visual assistant system according to claim 1, wherein the calculating device performs a wide-angle lens correction on the first eye image to output a wide-angle corrected image, performs a perspective correction on the wide-angle corrected image to generate a first forward eye image and a first side eye image, obtains a first pupil position and a first eyesight dioptre according to the first forward eye image and the first side eye image respectively, and calculates an object distance and a viewing direction according to the first eyesight dioptre and the first pupil position.

11. An imaging method of an eye-accommodation-aware head mounted visual assistant system, comprising:
capturing a first eye image via a first image sensor;
calculating an object distance and a viewing direction according to the first eye image; and
controlling a projecting light source to adjust an imaging position of an assistant information according to the object distance and adjust a projecting light angle and an angle of the beam splitter according to the viewing direction.

12. The imaging method according to claim 11, wherein the first image sensor is an infrared image sensor.

13. The imaging method according to claim 12, further comprising:
providing an infrared light to assist the infrared image sensor to capture the first eye image.

14. The imaging method according to claim 11, wherein the first image sensor is disposed at left inner side of the eyeglass frame.

15. The imaging method according to claim 11, wherein the first image sensor is disposed at right inner side of the eyeglass frame.

16. The imaging method according to claim 11, wherein the first image sensor is disposed at central inner side of the eyeglass frame.

17. The imaging method according to claim 11, wherein the calculation step comprises:
performing a perspective correction on the first eye image to generate a first forward eye image and a first side eye image;
obtaining a first pupil position and a first eyesight dioptre according to the first forward eye image and the first side eye image respectively; and
calculating an object distance and a viewing direction according to the first eyesight dioptre and the first pupil position.

18. The imaging method according to claim 11, further comprising:
capturing a second eye image via a second image sensor;
wherein, the calculation step calculates an object distance and a viewing direction according to the first eye image and the second eye image.

19. The imaging method according to claim 18, wherein the calculation step comprises:
performing a perspective correction on the first eye image to generate a first forward eye image and a first side eye image;
performing the perspective correction on the second eye image to generate a second forward eye image and a second side eye image;
obtaining a first pupil position and a first eyesight dioptre according to the first forward eye image and the first side eye image respectively;
obtaining a second pupil position and a second eyesight dioptre according to the second forward eye image and the second side eye image respectively; and
calculating an object distance and a viewing direction according to the first eyesight diopter, the second eyesight diopter, the first pupil position, and the second pupil position.

20. The imaging method according to claim 11, wherein the calculation step further comprises:
performing a wide-angle lens correction on the first eye image to output a wide-angle corrected image;
performing a perspective correction on the wide-angle corrected image to generate a first forward eye image and a first side eye image;
obtaining a first pupil position and a first eyesight dioptre according to the first forward eye image and the first side eye image respectively; and
calculating an object distance and a viewing direction according to the first eyesight dioptre and the first pupil position.
